(19) United States
(12) Patent Application Publication
(10) Pub. No.: US 2026/0310038 A1
(43) Pub. Date: Oct. 8, 2026

(54) ELECTRONIC INK DISPLAY DEVICE

(71) Applicant: E Ink Holdings Inc., HSINCHU (TW)

(72) Inventors: Lun-Hsuan CHEN, HSINCHU (TW); Chih-Chun CHEN, HSINCHU (TW); Wen-Chung YANG, HSINCHU (TW); Hung-En YANG, HSINCHU (TW); Tz-Iang CHEN, HSINCHU (TW)

(21) Appl. No.: 19/433,097

(22) Filed: Dec. 26, 2025

(30) Foreign Application Priority Data
Apr. 2, 2025 (TW) 114112874

(51) Int. Cl. G02F 1/1679; G02F 1/16755

(52) U.S. Cl. CPC G02F 1/1679; G02F 1/16755

(57) ABSTRACT

An electronic ink (E-ink) display device includes a thin film transistor (TFT) array substrate, at least two front panel laminates (FPLs), a protective sheet, and an edge sealant. The at least two FPLs are tiled on the TFT array substrate. A gap is present between adjacent two of the at least two FPLs. Each of the at least two FPLs includes an E-ink material layer. The protective sheet is disposed on the at least two FPLs to completely cover the at least two FPLs. The gap is filled by the edge sealant. The edge sealant is located between the TFT array substrate and the protective sheet.

### CROSS - REFERENCE TO RETLATED APPLICATION

This application claims priority to Taiwan Application Serial Number 114112874, filed Apr. 02, 2025, which is herein incorporated by reference in its entirety.

### BACKGROUND

### Field of Invention

The present disclosure relates to an electronic ink (E-ink) display device. More particularly, the present disclosure relates to an E-ink display device with at least two front panel laminates (FPLs) tiled on a single thin film transistor (TFT) array substrate.

### Description of Related Art

The E-ink display technology has characteristics of low power consumption, high contrast ratio, and wide viewing angle, and thus the E-ink display technology is suitable for static-state display applications. Currently, multiple E-ink display modules are tiled if the E-ink display technology is to be applied to large advertising pages. However, the manufacturing cost of multiple electronic ink display modules is high, and mechanical components are required to assist in tiling, which also increases the manufacturing cost. In addition, there will be obvious tiled seams greater than 2 mm between adjacent E-ink display modules, resulting in uneven display defects (also called mura), which in turn affects the viewing experience.

### SUMMARY

The present disclosure provides an electronic ink (E-ink) display device including a thin film transistor (TFT) array substrate, at least two front panel laminates (FPLs), a protective sheet, and a first edge sealant. The at least two FPLs are tiled on the TFT array substrate. A gap is present between adjacent two of the at least two FPLs. Each of the at least two FPLs includes an E-ink material layer. The protective sheet is disposed on the at least two FPLs to completely cover the at least two FPLs. The first edge sealant fills the gap. The first edge sealant is located between the TFT array substrate and the protective sheet.

In accordance with one or more embodiments of the present disclosure, the E-ink display device further includes a second edge sealant surrounding the at least two FPLs. The second edge sealant is arranged between the TFT array substrate and the protective sheet.

In accordance with one or more embodiments of the present disclosure, each of the at least two FPLs further includes a transparent substrate and a transparent electrode layer. The transparent substrate is attached to the protective sheet. The transparent electrode layer is located between the transparent substrate and the E-ink material layer. The E-ink material layer is located between the transparent electrode layer and the TFT array substrate.

In accordance with one or more embodiments of the present disclosure, each of the at least two FPLs further includes a conductive material sandwiched between the transparent electrode layer and the TFT array substrate and sandwiched between the E-ink material layer and the second edge sealant.

In accordance with one or more embodiments of the present disclosure, the TFT array substrate is a glass substrate.

In accordance with one or more embodiments of the present disclosure, the TFT array substrate is a flexible substrate.

In accordance with one or more embodiments of the present disclosure, the gap is present in a first direction between adjacent two of the at least two FPLs, and a seam is present in the first direction between an active area of the E-ink material layer of one of adjacent two of the at least two FPLs and an active area of the E-ink material layer of the other of adjacent two of the at least two FPLs, and a length of the seam in the first direction is less than 1 mm.

In accordance with one or more embodiments of the present disclosure, the protective sheet is a water-vapor-barrier sheet.

In accordance with one or more embodiments of the present disclosure, a material of the first edge sealant is identical to a material of the second edge sealant.

In accordance with one or more embodiments of the present disclosure, the first edge sealant is adhered to a first side wall of the E-ink material layer. The second edge sealant is adhered to a second side wall of the E-ink material layer. The first side wall and the second side wall are located on opposite sides of the E-ink material layer.

In accordance with one or more embodiments of the present disclosure, a material of the first edge sealant is a heat-curable, one-component, non-conductive, oxygen-barrier sealant.

In accordance with one or more embodiments of the present disclosure, a material of the transparent substrate is an optically clear adhesive (OCA).

The present disclosure further provides an E-ink display device including a TFT array substrate, a first transparent substrate, a second transparent substrate, a first transparent electrode layer, a second transparent electrode layer, a first E-ink material layer, a second E-ink material layer, and an edge sealant. The first transparent substrate and the second transparent substrate are tiled on the TFT array substrate. A gap is present between the first transparent substrate and the second transparent substrate. The first transparent electrode layer is located between the first transparent substrate and the TFT array substrate. The second transparent electrode layer is located between the second transparent substrate and the TFT array substrate. The first transparent electrode layer and the second transparent electrode layer are tiled on the TFT array substrate. The gap is present between the first transparent electrode layer and the second transparent electrode layer. The first E-ink material layer is located between the first transparent electrode layer and the TFT array substrate. The second E-ink material layer is located between the second transparent electrode layer and the TFT array substrate. The first E-ink material layer and the second E-ink material layer are tiled on the TFT array substrate. The gap is present between the first E-ink material layer and the second E-ink material layer. The edge sealant fills the gap.

In accordance with one or more embodiments of the present disclosure, the gap is present in a first direction between the first E-ink material layer and the second E-ink material layer. A seam is present in the first direction between an active area of the first E-ink material layer and an active area of the second E-ink material layer. A length of the seam in the first direction is less than 1 mm.

In accordance with one or more embodiments of the present disclosure, a material of the edge sealant is a heat-curable, one-component, non-conductive, oxygen-barrier sealant.

In order to make the above features and advantages of the present disclosure more apparent and understandable, the following embodiments of the present disclosure, together with the accompanying drawings, are described in detail below.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of the structure of an electronic ink (E-ink) display device according to some embodiments of the present disclosure.

FIG. 2 is a schematic diagram showing a seam of the E-ink display device according to some embodiments of the present disclosure.

### DETAILED DESCRIPTION

Specific embodiments of the present disclosure are further described in detail below with reference to the accompanying drawings. However, the embodiments described are not intended to limit the present disclosure and it is not intended for the description of operations to limit the order of implementation. The terms “first” and “second” used in the specification should be understood as identifying units or data described by the same terminology, and do not refer to a particular order or sequence.

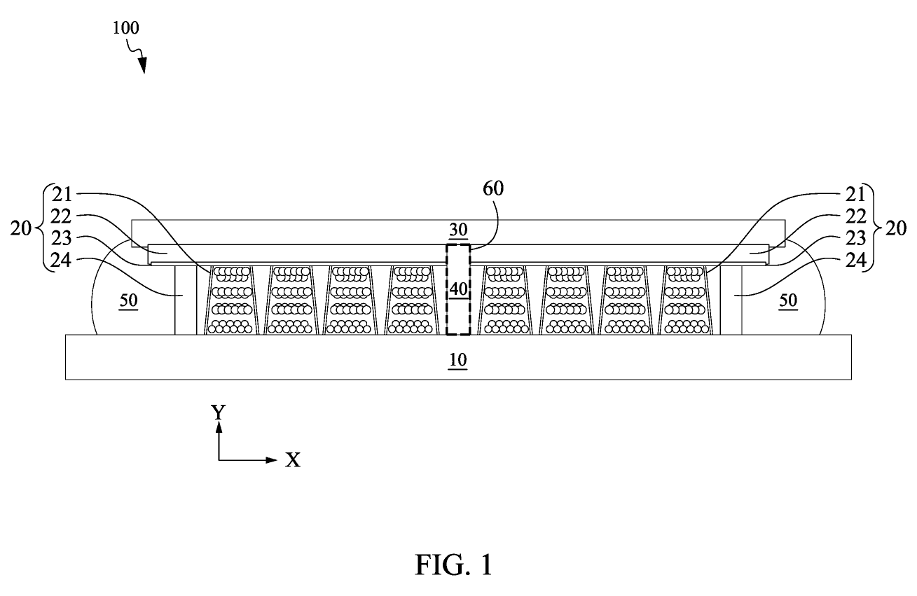

FIG. 1 is a schematic diagram of the structure of an electronic ink (E-ink) display device 100 according to some embodiments of the present disclosure. The E-ink display device includes a single thin film transistor (TFT) array substrate 10, plural front panel laminates (FPLs) 20, a protective sheet 30, a first edge sealant 40, and a second edge sealant 50. It should be noted that the number of the FPLs 20 as shown in FIG. 1 is two, but the present disclosure is not limited thereto. In some embodiments of the present disclosure, the number of the FPLs 20 is two or more.

The FPLs 20 are tiled on the single TFT array substrate 10. A gap 60 is present between adjacent two of the FPLs 20.

Each of the FPLs 20 includes an E-ink material layer 21, a transparent substrate 22, a transparent electrode layer 23, and a conductive material 24. The transparent electrode layer 23 is located between the transparent substrate 22 and the E-ink material layer 21. The E-ink material layer 21 is located between the transparent electrode layer 23 and the TFT array substrate 10.

Specifically, adjacent two of the transparent substrates 22 of the FPLs 20 are tiled on the TFT array substrate 10, and the gap 60 is present between the adjacent two of the transparent substrates 22 of the FPLs 20. Adjacent two of the transparent electrode layers 23 of the FPLs 20 are tiled on the TFT array substrate 10, and the gap 60 is present between the adjacent two of the transparent electrode layers 23 of the FPLs 20. Adjacent two of the E-ink material layers 21 of the FPLs 20 are tiled on the TFT array substrate 10, and the gap 60 is present between the adjacent two of the E-ink material layers 21 of the FPLs 20. The protective sheet 30 is disposed on the adjacent two of the transparent substrates 22 of the FPLs 20 to completely cover the adjacent two of the transparent substrates 22 of the FPLs 20.

The E-ink material layer 21 has display material (i.e., the electronic ink) which is operated by charged electronic ink particles and has bi-stable states. When an image signal is input into the E-ink display device 100, the electronic ink particles are moved according to the electric field, and an image according to the image signal is therefore displayed. The image displayed by the E-ink display device 100 can still be retained on the display even after the power supply is removed.

In some embodiments of the present disclosure, in order to avoid shielding the image displayed by the E-ink display device 100, the transparent substrate 22 can be formed by curing a light-transmitting adhesive material. For example, the material of the transparent substrate 22 is an optically clear adhesive (OCA) for attaching the protective sheet 30 (i.e., the transparent substrate 22 is attached to the protective sheet 30), but the present disclosure is not limited thereto. In some other embodiments of the present disclosure, the material of the transparent substrate 22 can be polyethylene terephthalate (PET), plastic, acrylic, or another appropriate material.

The material of the transparent electrode layer 23 may be indium tin oxide (ITO), indium zinc oxide (IZO), or another transparent conductive material.

The conductive material 24 is sandwiched between the transparent electrode layer 23 and the TFT array substrate 10. The conductive material 24 is sandwiched between the E-ink material layer 21 and the second edge sealant 50.

When the electric fields between the transparent electrode layer 23 and the pixel electrodes of the TFT array substrate 10 are varied, the electronic ink particles will be moved upwards or downwards in accordance with the direction of the electric fields, thereby enabling each pixel to show different colors and/or different optical characteristics. In some embodiments of the present disclosure, the TFT array substrate 10 is a glass substrate or a flexible substrate.

The protective sheet 30 is disposed on the FPLs 20 to completely cover the FPLs 20. Specifically, the protective sheet 30 is disposed on the FPLs 20, the first edge sealant 40 and the second edge sealant 50. The protective sheet 30 completely covers the FPLs 20 and the first edge sealant 40, and partially covers the second edge sealant 50. In some embodiments of the present disclosure, the protective sheet 30 is a water-vapor-barrier sheet.

The first edge sealant 40 is used for filling the gap 60. The first edge sealant 40 is located between the TFT array substrate 10 and the protective sheet 30. The first edge sealant 40 can prevent moisture from penetrating into the E-ink material layer 21 and enhance the moisture resistance of the E-ink display device 100.

The second edge sealant 50 surrounds the FPLs 20. The second edge sealant 50 is arranged between the TFT array substrate 10 and the protective sheet 30. In other words, the second edge sealant 50 is adjacent to the FPLs 20, the TFT array substrate 10 and the protective sheet 30. The second edge sealant 50 can prevent moisture from penetrating into the E-ink material layer 21 and enhance the moisture resistance of the E-ink display device 100.

The first edge sealant 40 is adhered to a first side wall of the E-ink material layer 21. The second edge sealant 50 is adhered to a second side wall of the E-ink material layer 21. The first side wall and the second side wall are located on opposite sides of the E-ink material layer 21.

In some embodiments of the present disclosure, the material of the first edge sealant 40 is identical to the material of the second edge sealant 50. In some embodiments of the present disclosure, the material of the first edge sealant 40 is a heat-curable, one-component, non-conductive, oxygen-barrier sealant. In other words, the first edge sealant 40 is an adhesive with low oxygen transmission rate (OTR) (also called high oxygen barrier property), such as Loctite 7301N epoxy adhesive, which is available from Henkel.

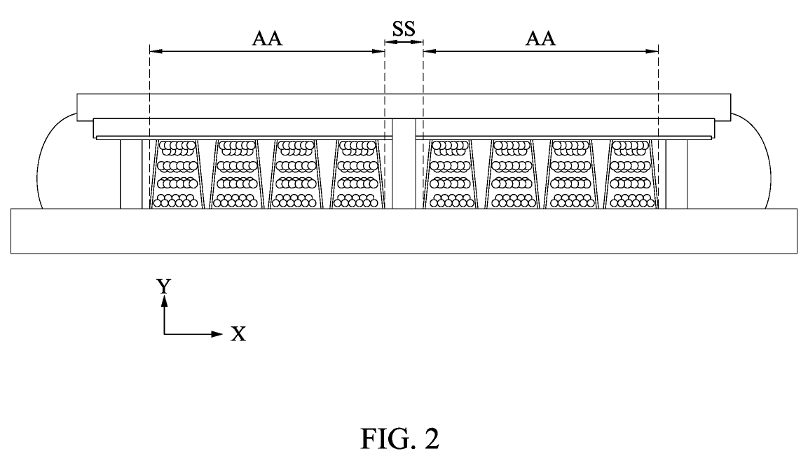

FIG. 2 is a schematic diagram showing a seam SS of the E-ink display device 100 according to some embodiments of the present disclosure. As shown in FIG. 1 and FIG. 2, the FPLs 20 are disposed on the TFT array substrate 10 along the direction Y, adjacent two of the FPLs 20 are tiled along the direction X. In addition, adjacent two of the FPLs 20 can also be tiled along the direction (i.e., the direction Z, not shown) orthogonal to the direction X and the direction Y.

As shown in FIGS. 1 and 2, the gap 60 is present in the direction X between adjacent two of the FPLs 20, and the gap 60 is present in the direction X between adjacent two of the E-ink material layers 21. A seam SS (i.e., the seam seen when viewing the E-ink display device 100) is present in the direction X between an active area (AA) of the E-ink material layers 21 of one of the adjacent two of the FPLs 20 and an active area (AA) of the E-ink material layers 21 of the other of the adjacent two of the FPLs 20. The length of the seam SS in the direction X is less than 1 mm.

According to the above, the length of the seam SS of the E-ink display device 100 of the present disclosure is less than 1 mm, achieving an extremely narrow seam without mura defects, thereby improving the viewing experience of applying E-ink display technology to large advertising pages.

In addition, the E-ink display device 100 of the present disclosure discloses that plural FPLs 20 are directly tiled on a single TFT array substrate 10 rather than tiling plural E-ink display modules of huge cost, thus saving manufacturing cost.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. An electronic ink display device, comprising:
a thin film transistor (TFT) array substrate;
at least two front panel laminates tiled on the TFT array substrate, wherein a gap is present between adjacent two of the at least two front panel laminates, wherein each of the at least two front panel laminates comprises an electronic ink material layer;
a protective sheet disposed on the at least two front panel laminates to completely cover the at least two front panel laminates; and
a first edge sealant configured to fill the gap, wherein the first edge sealant is located between the TFT array substrate and the protective sheet.

2. The electronic ink display device of claim 1, further comprising:
a second edge sealant surrounding the at least two front panel laminates, wherein the second edge sealant is arranged between the TFT array substrate and the protective sheet.

3. The electronic ink display device of claim 2, wherein each of the at least two front panel laminates further comprises:
a transparent substrate attached to the protective sheet; and
a transparent electrode layer located between the transparent substrate and the electronic ink material layer;
wherein the electronic ink material layer is located between the transparent electrode layer and the TFT array substrate.

4. The electronic ink display device of claim 3, wherein each of the at least two front panel laminates further comprises:
a conductive material sandwiched between the transparent electrode layer and the TFT array substrate and sandwiched between the electronic ink material layer and the second edge sealant.

5. The electronic ink display device of claim 1, wherein the TFT array substrate is a glass substrate.

6. The electronic ink display device of claim 1, wherein the TFT array substrate is a flexible substrate.

7. The electronic ink display device of claim 1, wherein the gap is present in a first direction between adjacent two of the at least two front panel laminates, and a seam is present in the first direction between an active area of the electronic ink material layer of one of adjacent two of the at least two front panel laminates and an active area of the electronic ink material layer of the other of adjacent two of the at least two front panel laminates, and a length of the seam in the first direction is less than 1 mm.

8. The electronic ink display device of claim 1, wherein the protective sheet is a water-vapor-barrier sheet.

9. The electronic ink display device of claim 2, wherein a material of the first edge sealant is identical to a material of the second edge sealant.

10. The electronic ink display device of claim 2, wherein the first edge sealant is adhered to a first side wall of the electronic ink material layer, wherein the second edge sealant is adhered to a second side wall of the electronic ink material layer, and the first side wall and the second side wall are located on opposite sides of the electronic ink material layer.

11. The electronic ink display device of claim 1, wherein a material of the first edge sealant is a heat-curable, one-component, non-conductive, oxygen-barrier sealant.

12. The electronic ink display device of claim 3, wherein a material of the transparent substrate is an optically clear adhesive.

13. An electronic ink display device, comprising:
a TFT array substrate;
a first transparent substrate and a second transparent substrate tiled on the TFT array substrate, wherein a gap is present between the first transparent substrate and the second transparent substrate;
a first transparent electrode layer located between the first transparent substrate and the TFT array substrate;
a second transparent electrode layer located between the second transparent substrate and the TFT array substrate, wherein the first transparent electrode layer and the second transparent electrode layer are tiled on the TFT array substrate, wherein the gap is present between the first transparent electrode layer and the second transparent electrode layer;
a first electronic ink material layer located between the first transparent electrode layer and the TFT array substrate;
a second electronic ink material layer located between the second transparent electrode layer and the TFT array substrate, wherein the first electronic ink material layer and the second electronic ink material layer are tiled on the TFT array substrate, wherein the gap is present between the first electronic ink material layer and the second electronic ink material layer; and
an edge sealant configured to fill the gap.

14. The electronic ink display device of claim 13, wherein the gap is present in a first direction between the first electronic ink material layer and the second electronic ink material layer, and a seam is present in the first direction between an active area of the first electronic ink material layer and an active area of the second electronic ink material layer, and a length of the seam in the first direction is less than 1 mm.

15. The electronic ink display device of claim 13, wherein a material of the edge sealant is a heat-curable, one-component, non-conductive, oxygen-barrier sealant.
